(19) United States
(12) Patent Application Publication
(10) Pub. No.: US 2017/0279845 A1
(43) Pub. Date: Sep. 28, 2017

(54) User Interface for Displaying and Comparing Attack Telemetry Resources

(71) Applicant: DataVisor Inc., Mountain View, CA (US)

(72) Inventors: Yang-hua Chu, Menlo Park, CA (US); Patrick Glenn Murray, Mountain View, CA (US); Shuo Shan, San Jose, CA (US); Yinglian Xie, Cupertino, CA (US); Ting-Fang Yen, Sunnyvale, CA (US); Fang Yu, Sunnyvale, CA (US); Yuhao Zheng, Sunnyvale, CA (US); Zilong Zhou, San Francisco, CA (US)

(73) Assignee: DataVisor Inc., Mountain View, CA (US)

(21) Appl. No.: 15/467,966

(22) Filed: Mar. 23, 2017

Related U.S. Application Data
(60) Provisional application No. 62/312,365, filed on Mar. 23, 2016.

(51) Int. Cl. H04L 29/06; G06F 3/0484

(52) U.S. Cl. CPC H04L 63/1441; H04L 63/1425; G06F 3/0484

(57) ABSTRACT

Methods, systems, and apparatus, including computer programs encoded on computer storage media, for displaying information about computer network resources identified as engaging in malicious activities. One of the systems includes one or more computers including one or more processors and one or more memory devices, the one or more computers configured to: identify resources associated with an attack, and provide an attach resource dashboard user interface that displays information related to attack resources, wherein the user interface presents resource information comparing behavior of a particular resource at a single online service with behavior of the resource at other online services, and comparing the behavior of that resource with behavior of other resources.

### CROSS-REFERENCE TO RELATED APPLICATIONS

This application claims the benefit under 35 U.S.C. §119(e) of the filing date of U.S. Patent Application No. 62/312,365, which was filed on Mar. 23, 2016, and which is incorporated here by reference.

### BACKGROUND

Network security relies on an ability to detect malicious user accounts. Malicious user accounts can be used to conduct malicious activities, for example, spamming, phishing, fake likes, and fraudulent transactions. Additionally, accounts can be used by particular resources that may also be used by legitimate users. Conventional solutions are dedicated to the display of information for one specific resource at one specific service.

### SUMMARY

This specification describes technologies related to user interfaces for displaying information about “entities.” For the purposes of this specification, an “entity” is defined as an attack resource that may be used by fraudulent accounts, including IP addresses, MAC addresses, host names, phone numbers, and email addresses. These resources can also be used by legitimate users. This specification describes the visualization and comparison of these resources to help understand attack strategies as well as the utilization of these resources particularly by fraudulent accounts.

Conventional solutions are dedicated to the display of information for one specific entity at one specific online service. Online services can include particular social media sites including social networks, review sites, and image sharing sites, as well as consumer services such as online bank or investment account access provided by a company. By contrast, a user analytics engine described in this specification provides a unique global vantage view into the activities of entities. This view is provided by ingesting event logs from multiple services across different sectors and geolocations. The system can display the comparison of the entity's behavior across different online services, as well as the comparison of one entity to other entities regarding their associated user activities.

One aspect of the subject matter described in this specification can be embodied in methods that include the actions of receiving an entity identifier as input on the console and presenting a summarized view interface. To initialize the interface, both the entity and the name of a specific online service is required. Presenting the summarized view interface further requires the display of several components, including the user count timeline view, usage pattern mosaic view, geolocation view, and the dynamic view, described below.

In general, one innovative aspect of the subject matter described in this specification can be embodied in systems that include one or more computers including one or more processors and one or more memory devices, the one or more computers configured to: identify resources associated with an attack; and provide an attach resource dashboard user interface that displays information related to attack resources, wherein the user interface presents resource information comparing behavior of a particular resource at a single online service with behavior of the resource at other online services, and comparing the behavior of that resource with behavior of other resources.

The foregoing and other embodiments can each optionally include one or more of the following features, alone or in combination. In particular, one embodiment includes all the following features in combination. The resources include IP addresses, phone numbers, email domains, or MAC addresses. The attack resources dashboard user interface provides a display that summarizes how a resource is interacting with particular online services. The display includes a timeline view that shows a size of a user population including a size of a new user population and a size of a malicious user population. The display includes a mosaic view that shows usage patterns for a group of resources. The mosaic view provides a display of a group of resources using a plurality of cells, each individual cell representing an individual resource, wherein a visual representation of each cell indicates a number of unique users associated with the corresponding resource. Neighboring cells of the mosaic represent neighboring or logically related resources. The display includes a geolocation view that shows a location of one or more resources as well as a location of users associated with the one or more resources. A location of a resource is associated with a particular map location indicating an origin of the resource. The location of the resource has a center computed based on median locations of users associated with that resource. The center is computed as a GPS location closest to a median value of GPS readings from event logs associated with the resource. The center is calculated according to:

(C_{latitude},C_{longitude})={(s_{latitude},s_{longitude}):minimum(dist(M,s)),∀s∈S}

where,
(C_{latitude}, C_{longitude}) is a latitude and longitude coordinates for the location center for the resource, M is the median value of GPS readings from event logs associated with the resource, and S is a set of all GPS readings from event logs associated with the resource. The location of the resource has a size calculated based on a user log and wherein the size indicates an estimated location variance associated with the resource. The display includes a dynamic view that quantifies how dynamic a user population associated with the particular resource is and how that value compares to other resources across other online services. The dynamic view indicates whether a specific online service is likely under attack.

In general, one innovative aspect of the subject matter described in this specification can be embodied in methods that include the actions of identifying malicious resources through analysis of obtained client data; and providing a plurality of user interface views through an attack resource dashboard that provides visualizations of a particular attack resources with respect to a particular online service and in comparison to a plurality of aggregate online services. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

In general, one innovative aspect of the subject matter described in this specification can be embodied in methods that include the actions of receiving a request from a client user to view an attack resources dashboard; providing the attack resources dashboard for presentation on a client user device; receiving a user selection of a particular attack resource; and providing one or more user interface visualizations of the attack resource. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages. The system obtains a comprehensive set of metrics to describe each attack resource element. This provides a richer feature set to determine whether events associated with the corresponding resources are legitimate or not. Many conventional solutions use a single score to describe an attack resource in a naive way. However, such a single score cannot be used to differentiate different attack cases, for example, a botnet IP address (where it is sometimes controlled by attackers) or a proxy IP address leveraged by attackers (where some users behind it is bad). In both cases, the single score provided by conventional systems may be the same.

The system compares attack resource usages in multiple dimensions from one online service to many other online services as an aggregate, so that it provides context to ascertain the legitimacy of a resource. For example, if an IP address is associated with many new user signups at one online service, but is a rarely used IP address by other online services, then such events are more suspicious even though no previous bad activities have been associated with this IP address.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating a system including a user analytics engine.

FIG. 2 illustrates an example user interface providing a user count timeline view.

FIG. 3 illustrates an example user interface providing a usage pattern mosaic view.

FIG. 4 illustrates an example user interface providing a usage pattern mosaic view.

FIG. 5 illustrates an example user interface providing a usage pattern mosaic view for a mobile device IP range.

FIG. 6 illustrates an example user interface providing a geolocation view.

FIG. 7 illustrates an example user interface of a dynamic view.

FIG. 8 is a flow diagram illustrating an example workflow of visualizing attack resources using the attack resource UI dashboard.

Like reference numbers and designations in the various drawings indicate like elements.

### DETAILED DESCRIPTION

This specification describes technologies related to user interfaces for displaying information about attack resources used by fraudulent accounts. The attack resources—which are referred to in this specification as “entities”—may be IP addresses, MAC addresses, phone numbers, email addresses, host names, or any set of the above (e.g., IP address prefixes). More specifically, the user interface presents a summarized view of how an entity is interacting with online services, the degree to which its activities are fraudulent or malicious, and how that compares with its activities at other online services and compared to other entities of the same type.

### Detecting Attack Resources

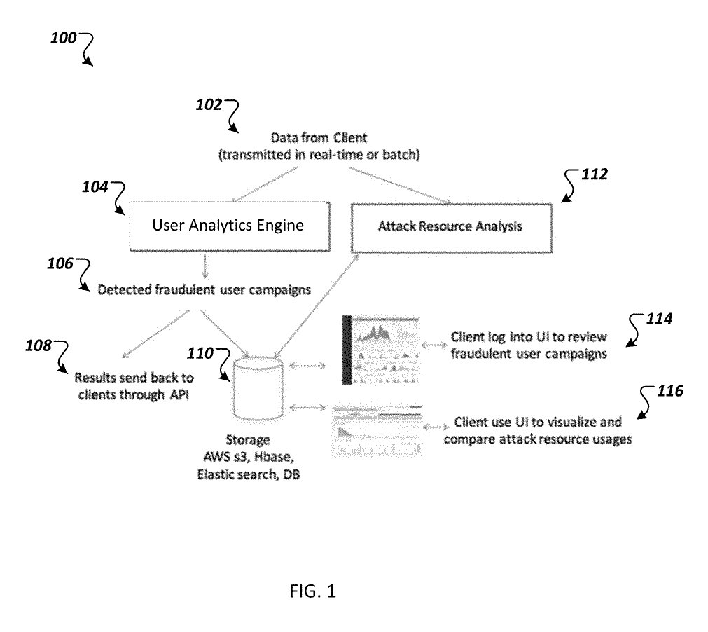

FIG. 1 is a diagram illustrating a system 100 including a user analytics engine 102. FIG. 1 shows the interaction between backend analytics system components and the frontend user interface (UI) components. The system takes user activity data from the client service either through API feed or via batch log upload (102). Then the system uses the user analytics engine to process the data (104). The user analytics engine can process the data in batch or in real time to detect fraudulent user campaigns (106).

The detected fraudulent users, together with their campaign information, are sent back to the client service through API (108). In addition, the fraudulent user campaign information is also stored (110). The fraudulent user campaign information can be stored in one or more storage systems such as SQL databases, cloud storage systems (e.g., AWS S3), index and search systems (e.g., Elastic Search), NoSQL systems (e.g., Hbase), or traditional file systems. An attack resource analysis module takes both the user activity data from the client service and the computed attack campaign data derived from the user analytics engine to perform attack resource analysis 112. The derived attack resource statistics and comparison results will be stored in the same one or more storage systems 110. The client can access the stored information 110, for example, by logging into an application or network location providing a II representation of the malicious user campaign(s) 114 or an attack resource display dashboard 116 that reads information from the storage systems and displays it to the clients.

Techniques for detecting attack campaigns are described in greater detail in U.S. patent application Ser. No. 14/620,028 filed on Feb. 11, 2015, Ser. No. 14/620,048 filed on Feb. 11, 2015, Ser. No. 14/620,062 filed on Feb. 11, 2015, and Ser. No. 14/620,029 filed on Feb. 11, 2015, which are each incorporated here by reference.

### User Count Timeline View

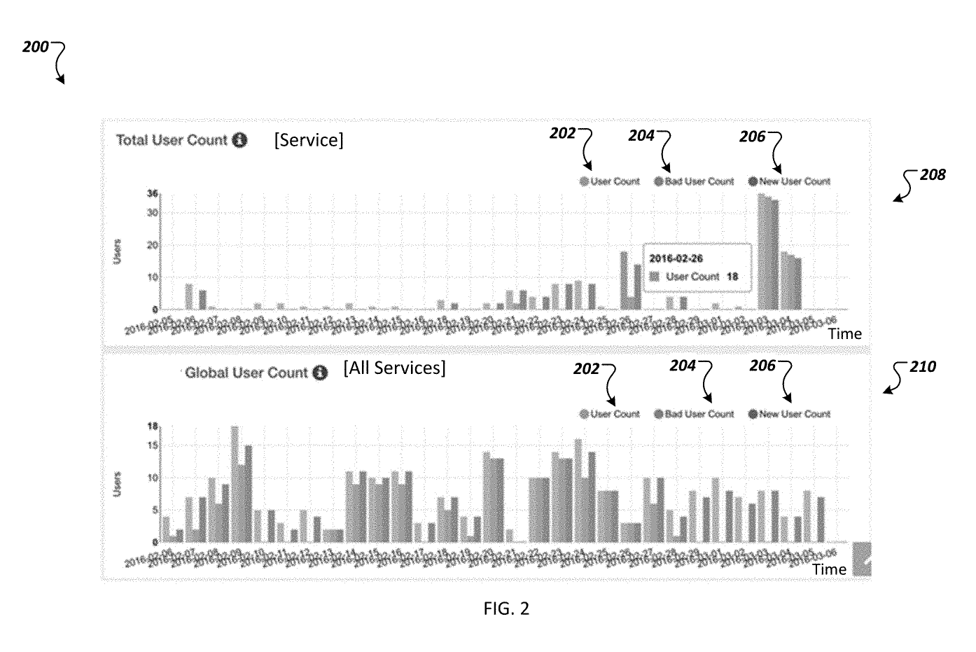

In some implementations, the system provides a user interface that selectively presents a user count timeline view. FIG. 2 illustrates an example user interface providing a user count timeline view 200. The user count timeline view 200 displays the number of unique user accounts associated with the entity each day. Three numbers are shown each day: the total number of unique user accounts 202, the number of unique newly registered user accounts 204, and the number of unique malicious user accounts 206, e.g., as detected by the user analytics engine. The timeline view includes two sections, one for the specified online service 208 (top timeline) and the other an aggregate of data from all other online services 210 (bottom timeline), not including the particular specified online service. In both sections, the X-axis is time, the Y-axis is the user count.

The user count timeline view 200 provides insights into the usage pattern of the entity over time, such as the expected number of daily users and weekday vs. weekend patterns. A spike in the number of newly registered users may be indicative of malicious activities (such as the mass registration of fake user accounts), while an increase in the number of detected malicious accounts signals an attack on the online service. For example, as shown in the top timeline, a spike 212 in the “bad user count” (detected malicious user accounts) for the service is illustrated around March 4th-March 5, which indicates a possible attack.

### Usage Pattern Mosaic View

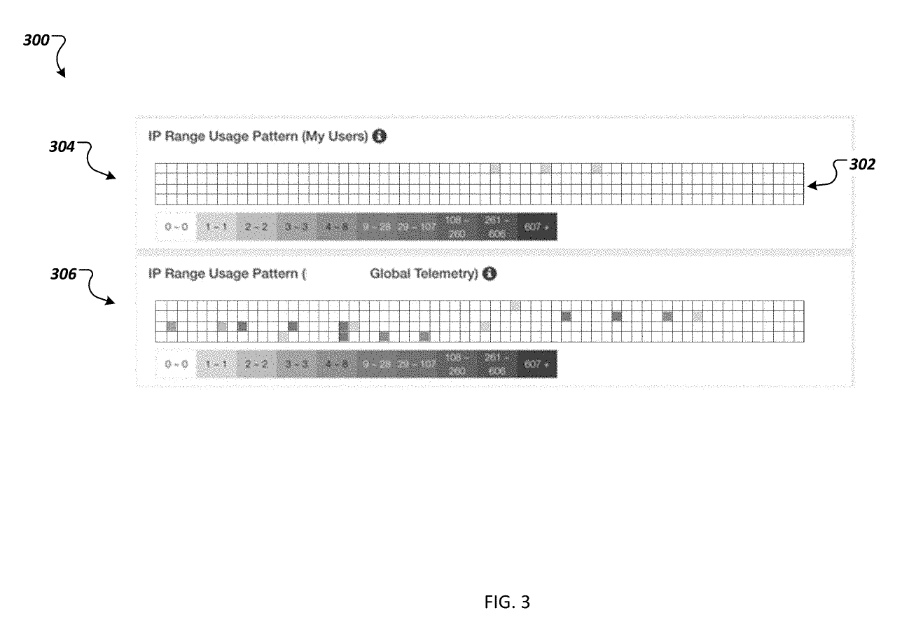

In some implementations, the system provides a user interface that selectively presents a usage pattern mosaic view. FIG. 3 illustrates an example user interface providing a usage pattern mosaic view 300. The usage pattern mosaic view 300 displays a usage pattern for a set of entities that are logically grouped together, such as an IP address subnet, phone number prefix, or email domain. In the example shown in FIG. 3, the usage pattern mosaic view 300 represents 256 IP addresses in a /24 IP subnet 302. The shade of each cell indicates the number of users found to be active on that IP address. The darker the shading or color for each cell, the more active the IP address. Similar to the user count timeline view 200, there are two sections—one for a particular specified online services 304 (top), the other an aggregate of data from all other online services 306 (bottom). Thus, for a specific online service, the system can present a timeline for that specified online service as compared to global data that aggregates other online services

The usage pattern mosaic view 300 provides valuable insight for the online service for two major purposes. The first purpose goes beyond detecting fraudulent user accounts: the information can be used for growing or acquiring legitimate users related with the associated entities. For example, if the mosaic from the specified online service 304 is mostly empty, while the mosaic from the aggregated data 306 is packed with many dark boxes, it indicates under-utilization for the specified online service and suggests that the online service may still be able to engage a larger set of legitimate users associated with the corresponding entities.

An example of under-utilization is shown in FIG. 3. As shown in FIG. 3, globally, there are many active users in this example IP range 306 (bottom portion). However, the specified online service 304 (top portion) does not engage with most of them, so the online service still has a large room to grow users from the same IP range.

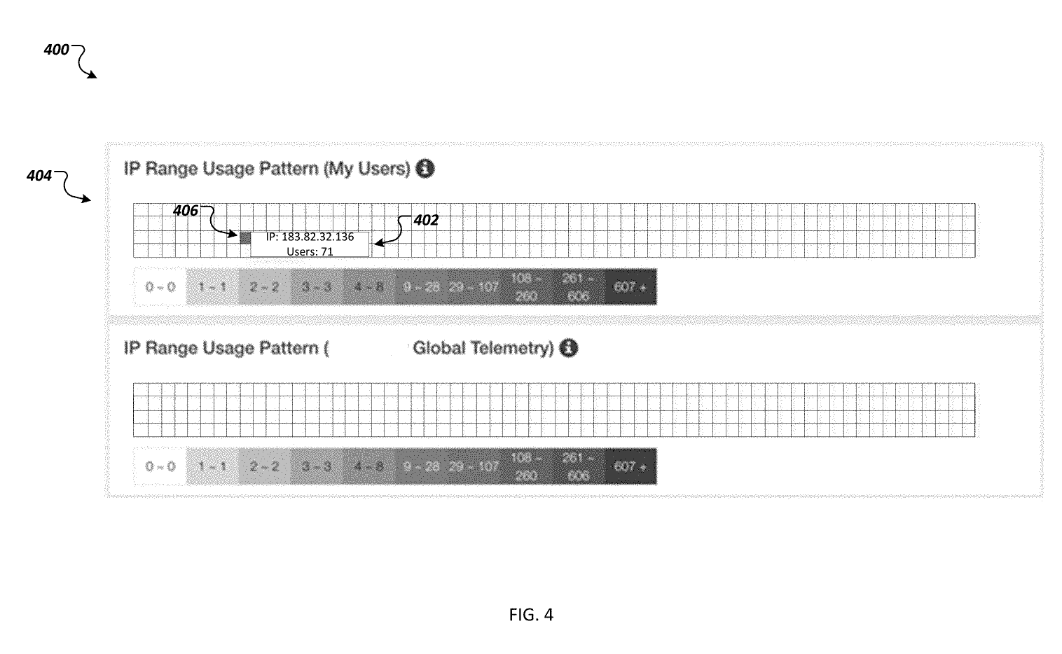

A second purpose of the usage pattern mosaic view is detecting fraudulent users. For example, if the specified online service (top portion) shows heavy activities on some cells, e.g., one cell has 1000 unique user's activities, while the same cell in the aggregated data (bottom portion) has almost no activity, it is highly suspicious and an indication of fraudulent user activities related with the heavy activity patterns on the online service. This is because it is almost impossible for one online service to have 1000 unique users on one entity (e.g., a single IP), while the same entity the same IP) or the nearby related entities (e.g., the corresponding IP subnet) is never used by any other online service. It is highly likely that this entity (e.g., IP address) is used by the attacker, e.g., as a proxy IP. An attack scenario is illustrated by the mosaic view of FIG. 4.

FIG. 4 illustrates an example user interface providing a usage pattern mosaic view 400. To help examine the data points easily, upon mouse-over of individual cells, alt-text, or hover text 402, may display the entity name (e.g., IP address) corresponding to the cell, as well as the exact number of users found to be active on that entity. For example, as shown in FIG. 4, a user has selected or hovered over a particular cell 406 in the specified online service portion 404. The text for the cell indicates the IP address of the cell and that it has 71 users.

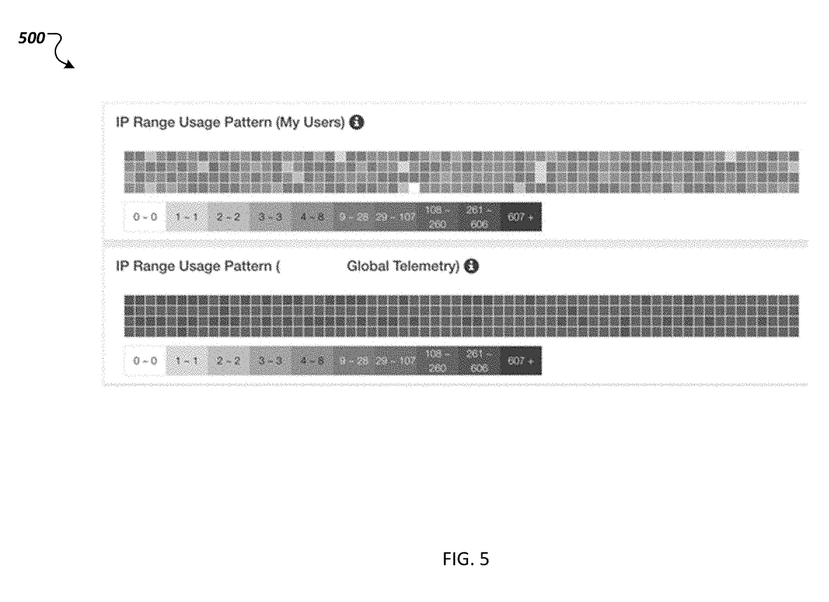

For some types of resources, the user pattern mosaic view can be used to help infer the nature or the specific categories of the related entities in a more fine-grained way. For example, if the resource is a particular IP address, the mosaic view of a specific IP range can be used to infer the corresponding IP range type such as cellular mobile ranges or data center ranges. IP ranges used by all mobile cellular devices tend to be extremely densely utilized since they are often shared by a large number of mobile devices. FIG. 5 illustrates an example user pattern mosaic view 500 for IP addresses used by mobile devices. The user pattern mosaic view 500 illustrates the heavy usage of the IP range.

### Geolocation View

In some implementations, the system provides a user interface that selectively presents a geolocation view. The geolocation view displays the location of the entity. In addition to geolocation data obtained from third-party providers for applicable entity types like IP addresses or phone prefixes (marked as a blue box in the map below), the user analytics engine can also compute geolocations of an entity using GPS information provided by online services from the event logs sent to the system. (marked as a yellow circle in the map below).

As GPS readings reported by different user accounts may be different, the system computes a reported GPS location range from the log data, rather than displaying all individual GPS readings. The derived UPS location range may be further used by the user analytics engine for attack detection, or sent back to clients as a telemetry signal to serve as an input to their attack detection system.

### Geolocation View—Use Cases

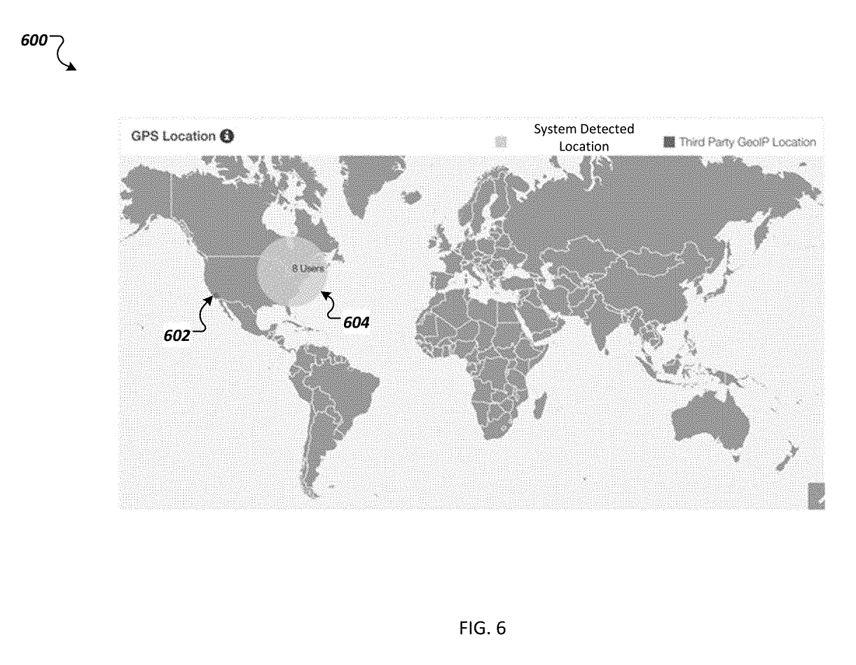

FIG. 6 illustrates an example user interface providing a geolocation view 600. The geolocation view 600 includes a map representation 602 as well as one or more plotted circles indicating entity location. The system plots GPS locations on the map using circles of varying sizes. The area covered by a circle denotes the most likely geolocations associated with the corresponding entities. The circle size denotes the estimated region size of the likely geolocations.

The geolocation view may help infer the mobility behaviors of the user accounts that have used or will use the corresponding entities. For example, if the entity is an IP address and the circle size is very small on the geolocation view 600, for example, circle 602, it means the entity has a very precise location, e.g., an IP used by a specific enterprise company in one building. If the circle has a large radius, e.g., circle 604, it means that the geolocation of the user accounts that originate from that IP address is not stable or has a large variation. This could be an indication of the IP range being a cellular range, VPNs, proxies, or used for satellite communication. If the location from third-party data providers does not match a calculated location by the system from UPS data, it indicates that the third-party data may be out-dated or erroneous, which can happen frequently for geolocation data.

In addition to IP addresses, the sizes of the circles give insight into the nature of other types of entities as well. For example, if the entity is an email domain and the circle size is small on the geolocation view, it is likely that the email domain belongs to an organization with close affiliation to its users, such as universities or local businesses.

### Geolocation View—Display Location Algorithm

To compute a display position of the circle on the map in the geolocation view, the system sets its center to the GPS reading closest to the median value of UPS readings from all event logs provided by the online service associated with the specified entity. This ensures that the circle center corresponds to an actual location, and not on an uninhabited island or out on the open ocean as can happen when one simply takes the median value.

An example technique for computing the display position of the circle on the map follows: Let M denote the median value of UPS readings from all event logs associated with the specified entity, where M=(M_{latitude}, M_{longitude}). S is the set of all GPS readings from event logs associated with the specified entity, where S={s₁, s₂, . . . , sₙ}. Let dist(x,y) denote the distance from point x to y. The latitude and longitude for the center C of the circle can then be computed by:

(C_{latitude},C_{longitude})={(s_{latitude},s_{longitude}):minimum(dist(M,s)),∀s∈S}

The radius of the circle can be computed, for example, by the following formula. It first computes the distance from the circle center to all GPS readings associated with the specified IP. The circle radius is then set to the 90th percentile of the distances.

radius=percentile(0.9,[dist(C,s₁),dist(C,s₂), . . . , dist(C,sₙ)])

### Dynamic View

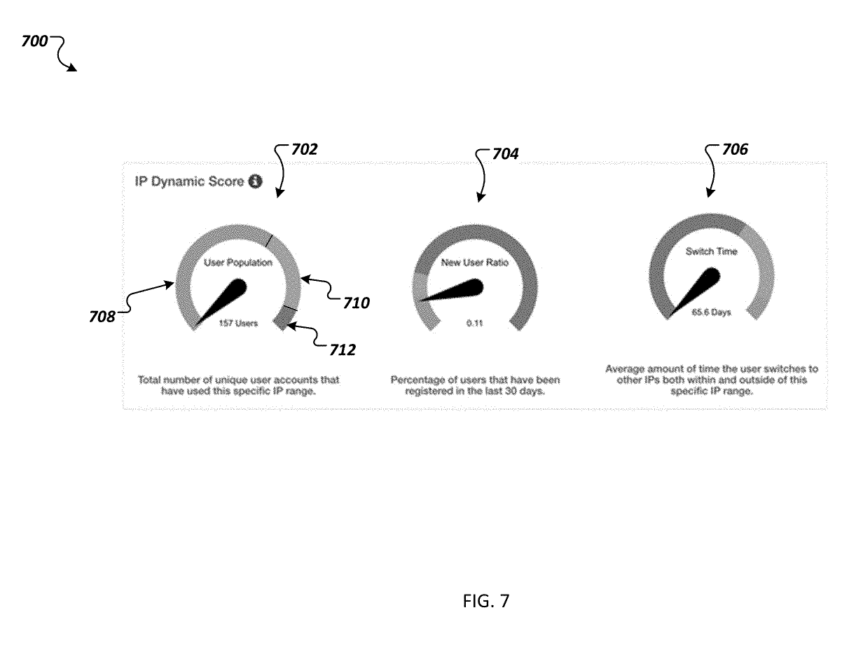

In some implementations, the system provides a user interface that selectively presents a dynamic view. FIG. 7 illustrates an example user interface of a dynamic view 700. The dynamic view 700 displays metrics that quantify the “dynamicity” of the user population associated with a set of entities, such as an IP address subnet. In particular, the metrics are displayed relative to a global value, i.e., computed using aggregated data from all other online services. This provides an easy way for a specific online service to see how the same population of user accounts interact with it versus other online services.

The dynamic view 700 includes multiple sections. A user population section 702 illustrates a size of a user population associated with an entity. A new user ratio section 704 illustrates a percentage of new users associated with the entity. A switch time portion 706 illustrates an average amount of time where a user account is associated with the entity (e.g., how long until the user account switches to a different IP address). In some implementation, the dynamic view can include other sections including, for example, a least time section illustrating an average length of time during which a user is associated with the entity and an entity count section illustrating an average number of other entities (of the same type) a user is associated with, among users associated with the entity.

The system uses visual indicators such as colors to indicate how dynamic this entity is at a specific online service, compared to other online services. The visual indicators also serve to alert the clients on suspicious activities. Take the user population section 702 as an example. Let Pₘᵢₙ and Pₘₐₓ indicate the minimum and maximum user population associated this entity at all other online services. For example, if 0≦P<0.75*Pₘₐₓ, the system may display a green color 708 in the dynamic view to indicate everything looks normal, The range 0.75*Pₘₐₓ≦P<1.2*Pₘₐₓ is colored orange 710 to show alert, and anything equal or greater than 1.2*Pₘₐₓ is colored red 712 to show a strong indication of a likelihood of malicious activities.

An unusually high new user ratio may indicate a high likelihood that the specified online service is undergoing a mass registration attack, while an unusually high switch time may indicate a high likelihood that proxies are being used—a common tactic used by attackers to hide the true origin of their traffic.

### Attack Resource UI Dashboard Workflow

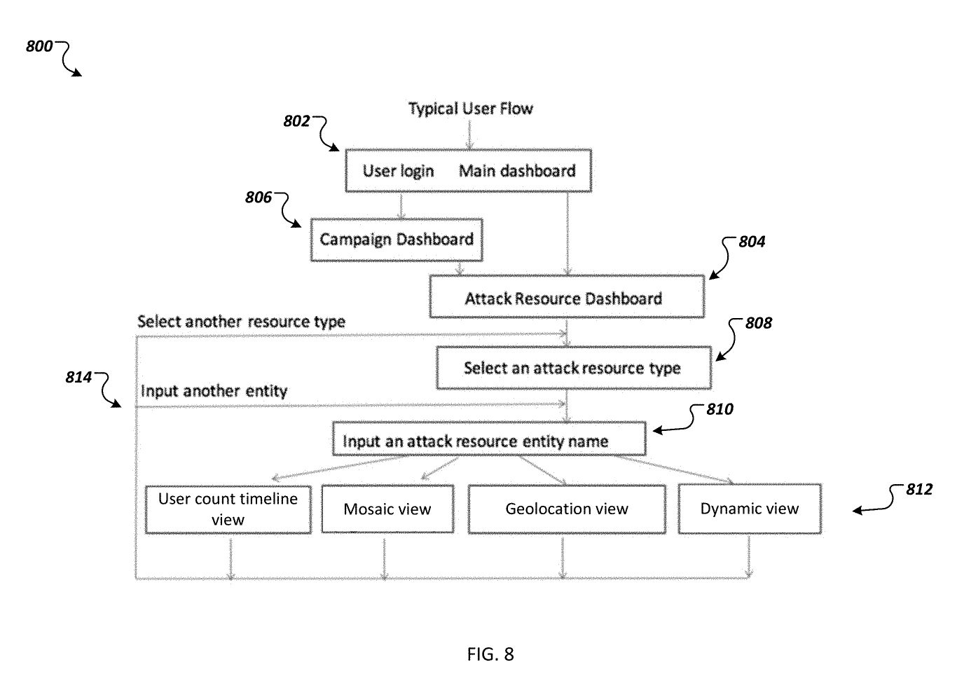

FIG. 8 is a flow diagram illustrating an example workflow 800 of visualizing attack resources using the attack resource UI dashboard. After a client logs into a main dashboard of the user analytics UI (802), the client can navigate to the attack resource dashboard either directly (804) or indirectly via other dashboards that contain links pointing to the attack resource dashboard, for example, through a campaign dashboard (806). From the attack resource dashboard, the client can select an attack resource type (808) and further input an entity name (810) to pull out the different views in one or multiple pages and visualize them (812). After viewing the details of one input resource entity, the client can select another resource type or input another entity name (814) and visualize different views again, following the repeated work flow.

In this specification the term “engine” will be used broadly to refer to a software based system or subsystem that can perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

In this specification, the term “database” is used broadly to refer to any collection of data: the data does not need to be structured in any particular way, or structured at all, and it can be stored on storage devices in one or more locations.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or electronic system that may include one or more processing devices and memory to store executable instructions to perform the operations described in this specification.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising:
one or more computers including one or more processors and one or more memory devices, the one or more computers configured to:
identify resources associated with an attack; and
provide an attach resource dashboard user interface that displays information related to attack resources, wherein the user interface presents resource information comparing behavior of a particular resource at a single online service with behavior of the resource at other online services, and comparing the behavior of that resource with behavior of other resources.

2. The system of claim 1, wherein the resources include IP addresses, phone numbers, email domains, or MAC addresses.

3. The system of claim 1, wherein the attack resources dashboard user interface provides a display that summarizes how a resource is interacting with particular online services.

4. The system of claim 3, wherein the display includes a timeline view that shows a size of a user population including a size of a new user population and a size of a malicious user population.

5. The system of claim 3, wherein the display includes a mosaic view that shows usage patterns for a group of resources.

6. The system of claim 5, wherein the mosaic view provides a display of a group of resources using a plurality of cells, each individual cell representing an individual resource, wherein a visual representation of each cell indicates a number of unique users associated with the corresponding resource.

7. The system of claim 6, wherein neighboring cells of the mosaic, represent neighboring or logically related resources.

8. The system of claim 3, wherein the display includes a geolocation view that shows a location of one or more resources as well as a location of users associated with the one or more resources.

9. The system of claim 8, wherein a location of a resource is associated with a particular map location indicating an origin of the resource.

10. The system of claim 9, wherein the location of the resource has a center computed based on median locations of users associated with that resource.

11. The system of claim 10, wherein the center is computed as a GPS location closest to a median value of GPS readings from event logs associated with the resource.

12. The system of claim 11, wherein the center is calculated according to:
(C_{latitude},C_{longitude})={(s_{latitude},s_{longitude}):minimum(dist(M,s)),∀s∈S}
where, (C_{latitude}, C_{longitude}) is a latitude and longitude coordinates for the location center for the resource, M is the median value of UPS readings from event logs associated with the resource, and S is a set of all UPS readings from event logs associated with the resource.

13. The system of claim 9, wherein the location of the resource has a size calculated based on a user log and wherein the size indicates an estimated location variance associated with the resource.

14. The system of claim 3, wherein the display includes a dynamic view that quantifies how dynamic a user population associated with the particular resource is and how that value compares to other resources across other online services.

15. The system of claim 13, wherein the dynamic view indicates whether a specific online service is likely under attack.

16. A method comprising:
identifying malicious resources through analysis of obtained client data; and
providing a plurality of user interface views through an attack resource dashboard that provides visualizations of a particular attack resources with respect to a particular online service and in comparison to a plurality of aggregate online services.

17. A method comprising:
receiving a request from a client user to view an attack resources dashboard;
providing the attack resources dashboard for presentation on a client user device;
receiving a user selection of a particular attack resource; and
providing one or more user interface visualizations of the attack resource.
